(19) United States
(12) Patent Application Publication
(10) Pub. No.: US 2026/0104151 A1
(43) Pub. Date: Apr. 16, 2026

(54) METHODS AND DEVICES FOR SOLAR POWERED LIGHT ASSEMBLIES

(71) Applicant: SPIRIT FIRE, LLC, Holland, MI (US)

(72) Inventor: Luciano Hernandez, Jr., Fennville, MI (US)

(21) Appl. No.: 19/419,677

(22) Filed: Dec. 15, 2025

Related U.S. Application Data
(63) Continuation of application No. PCT/US24/34142, filed on Jun. 14, 2024.
(60) Provisional application No. 63/508,724, filed on Jun. 16, 2023.

(51) Int. Cl. F21S 41/663; F21S 9/03; F21V 21/096; F21V 23/04

(52) U.S. Cl. CPC F21S 41/663; F21S 9/037; F21V 21/096; F21V 23/0464

(57) ABSTRACT

A light assembly may include a housing defining a sealed cavity, at least one light, a solar cell, a battery, one or more sensors including at least an accelerometer and a light sensor, a microprocessor and memory configured to store computer-readable instructions thereon, wherein the at least one light, the battery, the solar cell, and the one or more sensors are electronically interconnected with the microprocessor and the memory, and wherein the microprocessor is configured to activate the at least one light to an on condition when the ambient light level is below a predefined light level and when at least one of: the acceleration of the vehicle is above a predefined acceleration level, or the acceleration of the vehicle indicates a direction of travel is at least substantially aligned with a light projection direction of the at least one light.

### CROSS-REFERENCE TO RELATED APPLICATIONS

This application is a continuation of PCT Application Ser. No. PCT/US2024/034142, filed Jun. 14, 2024 and published as WO 2024/259329, which claims the priority benefit of U.S. Provisional Application No. 63/508,724, filed Jun. 16, 2023, the disclosure of which is herein incorporated by reference in its entirety.

### TECHNICAL FIELD

The disclosure relates in general to light assemblies, and more particularly, to a light assembly that is attachable to an outside surface, which can be recharged through solar power, and which can, through sensors determine whether to be on or off, that is, whether or not to power one or more lights that are maintained therewithin. Among other outside surfaces, the light is particularly useful for attachment to vehicles, such as cars, trucks (e.g., pickup truck, semi-truck, tractor-trailer, etc.), tractors, equipment, lawnmowers, motorcycles, trailers, off road vehicles, watercraft, etc.

### BACKGROUND

The use of lights, lamps, and the like on vehicles is known in the art. Typically, such lights are powered by the vehicle battery and can be positioned on different places on the vehicle.

### SUMMARY

In some aspects, the techniques described herein relate to a light assembly for removably coupling to a vehicle, the light assembly including: a housing defining a sealed cavity, the housing being at least partially transparent or translucent; at least one light configured to project light in a light projection direction through a lens portion of the housing; a solar cell configured to receive sunlight at least partially through the housing; a battery electrically coupled to the solar cell and the at least one light; two or more sensors, the two or more sensors including at least a movement sensor and a light sensor; and a microprocessor and memory configured to store computer-readable instructions thereon, wherein the at least one light, the battery, the solar cell, and the two or more sensors are electronically interconnected with the microprocessor and the memory, and wherein the microprocessor is configured to execute one or more operations based on the instructions stored in the memory, the operations including: receiving one or more first sensor measurements from the light sensor; determining an ambient light level based on the one or more first sensor measurements; receiving one or more second sensor measurements from the movement sensor; determining at least one of: an acceleration or a direction of travel of the vehicle from the one or more second sensor measurements; and activating the at least one light to an on condition when: the ambient light level is below a predefined light level, and at least one of: the acceleration of the vehicle is above a predefined acceleration level, or the acceleration of the vehicle indicates the direction of travel is at least substantially aligned with the light projection direction of the at least one light.

In some aspects, the techniques described herein relate to a method of using a light assembly including a microprocessor and memory configured to store computer-readable instructions thereon, wherein the microprocessor is configured to execute one or more operations including: receiving one or more first sensor measurements from a light sensor; determining an ambient light level based on the one or more first sensor measurements; receiving one or more second sensor measurements from a movement sensor; determining at least one of: an acceleration of a vehicle or a direction of travel of the vehicle upon which the light assembly is mounted based on the one or more second sensor measurements; and directing a light to an on condition based on an ambient light level measurement less than a predefined level and at least one of: determining that the acceleration is greater than a predefined level, or determining that the acceleration indicates the direction of travel of the vehicle is at least substantially aligned with a light projection direction of the light assembly.

In some aspects, the techniques described herein relate to a method of lighting a vehicle, including: adhering a light assembly on an outer surface of the vehicle, the light assembly including: a housing defining a sealed cavity, the housing having a lens portion and a charging portion, the lens portion and the charging portion each being at least one of transparent and translucent, at least one light, a solar cell, a battery, two or more sensors, the two or more sensors including at least an accelerometer and a light sensor, and a microprocessor; directing the at least one light to an on condition based on an ambient light level measurement from the light sensor less than a predefined level and at least one of: determining that an acceleration measured by the accelerometer is greater than a predefined level, or determining that the acceleration measured by the accelerometer indicates the direction of travel of the vehicle is at least substantially aligned with a light projection direction of the light assembly.

In some aspects, the techniques described herein relate to a light assembly for removably coupling to a vehicle, the light assembly including: a housing defining a sealed cavity, the housing being at least partially transparent or translucent; at least one light configured to project light through a lens portion of the housing defining a light projection direction; a battery electrically coupled to the at least one light; two or more sensors, the two or more sensors including at least a movement sensor and a light sensor; and a microprocessor and memory configured to store computer-readable instructions thereon, wherein the at least one light, the battery, and the two or more sensors are electronically interconnected with the microprocessor and the memory, wherein the light assembly is configured such that the light projection direction is substantially aligned with a direction of travel of the vehicle, and wherein the light assembly is configured to direct one or more lights to an on condition based on an ambient light level measurement from the light sensor less than a predefined level and at least one of: an acceleration measured by the movement sensor is greater than a predefined level, or an acceleration vector measured by the movement sensor is at least substantially parallel to a longitudinal axis of the light assembly and oriented substantially opposite of the light projection direction.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a partial perspective view of a plurality of light assemblies of an embodiment installed on a vehicle.

FIG. 2 illustrates a side elevational view of an embodiment of a light assembly.

FIG. 3 illustrates a top plan view of an embodiment of a light assembly.

FIG. 4 illustrates an exploded view of an embodiment of a light assembly.

FIG. 5 illustrates a block diagram representative of an embodiment a light assembly.

FIG. 6 illustrates an embodiment of a method of using a solar powered light assembly.

FIG. 7 illustrates a top plan view of an embodiment of a light assembly with a longitudinal axis that is approximately parallel to the projection direction of the light assembly.

FIG. 8 illustrates a side elevational view of an embodiment of a light assembly with a longitudinal axis that is approximately parallel to the projection direction of the light assembly.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

The use of the term vehicle is intended to include a variety of vehicle types for the transportation of people and material. For example, a vehicle may be a car, a truck, a semi-truck, a tractor, a piece of equipment, a boat, a kayak, a motorcycle, a bicycle, a paddleboard, etc.

Conventional lighting assemblies for installation on vehicles include several technical problems. For example, conventional lighting assemblies are difficult to wire into the vehicle's power system (especially on a retrofit) to properly power the light. Providing the wiring often includes drilling holes in an otherwise waterproof vehicle (e.g., boats, trucks, etc.) or enclosure of a vehicle. Drilling holes in waterproof vehicles greatly increases the risk of leaks. In addition, it is often difficult to provide the wiring for the switch and determine appropriate switch placement. Often, it is too difficult to install such lights. In other conventional lighting assemblies, the lights may include on/off switches, but the user may forget to turn off or on the lights because they are not readily accessible when the user is operating the vehicle. In other instances, a user may forget to turn off such lights, which eventually drains the battery of the vehicle (e.g., especially where the vehicle is not accessed or utilized often).

The light assemblies provided herein solve the above technical problems with technical solutions. For example, the lighting assemblies provided herein may utilize advantageous mounting mechanisms (e.g., adhesive pads, magnets, etc.) or combinations thereof. Further, light assemblies provided herein may include one or more batteries rechargeable via one or more solar cells. Further, light assemblies provided herein may include two or more sensors for indication of appropriate light activation. One of the two or more sensors may be a light sensor for measuring ambient light amounts. One of the two or more sensors may be a movement sensor (e.g., an accelerometer) for measuring accelerations of a vehicle the light assembly is mounted upon. Light assemblies provided herein may direct one or more lights to an on condition when at least two conditions are met. For example, the light assembly may direct one or more lights to an on condition if an ambient light level measurement from the light sensor is less than a predefined level and at least one of: an acceleration measured by the movement sensor is greater than a predefined level, or the acceleration measured by the movement sensor indicates the direction of travel of the vehicle is at least substantially aligned with a light projection direction of the light assembly. Light assemblies described herein may include a variety of uses. For example, the light assemblies may be used for the marking of a vehicle, the illumination of a vehicle's path, or as signaling (e.g., advantageous during search and rescue operations).

Further, conventional lighting systems include at least one vibrometer to produce a signal to, in part, cause the control circuitry to direct a light to an “on” condition or activated state. The technical problem with vibrometers is that they include several inherent issues. Vibrometers cause unreliable and/or undesirable performance of the light assembly. For example, vibrometers, typically used to observe low-frequency large-structure vibrations (e.g., buildings, bridges, etc.), are not well suited for the frequencies and amplitudes of accelerations experienced on a vehicle on which the assembly is installed. Further, vibrometers may not be well suited to differentiate between targeted signals and environmental noise (e.g., wind, rain, etc.). Further, vibrometers do not recognize other defining characteristics of accelerations, for example, the orientation of an acceleration (e.g., with respect to gravity). Additionally, the response time for vibrometers is long when compared to other similar sensors. The technical solution provided herein to solve the above technical problems is to employ an accelerometer. Accelerometers may be activatable within milliseconds compared to some vibrometers requiring seconds. Various embodiments described herein utilize accelerometers for the measurement of accelerations (e.g., vibrational) due to the resolution that may be provided between targeted signals and environmental noise (e.g., wind, rain, etc.). Resolution between targeted signals and environmental noise allows for predefined acceleration levels to be measured and set, which increases reliability and decreases undesirable performance. Further, some embodiments described herein may use accelerometers to measure the orientation of accelerations to eliminate untargeted acceleration signals and/or to define a direction of travel.

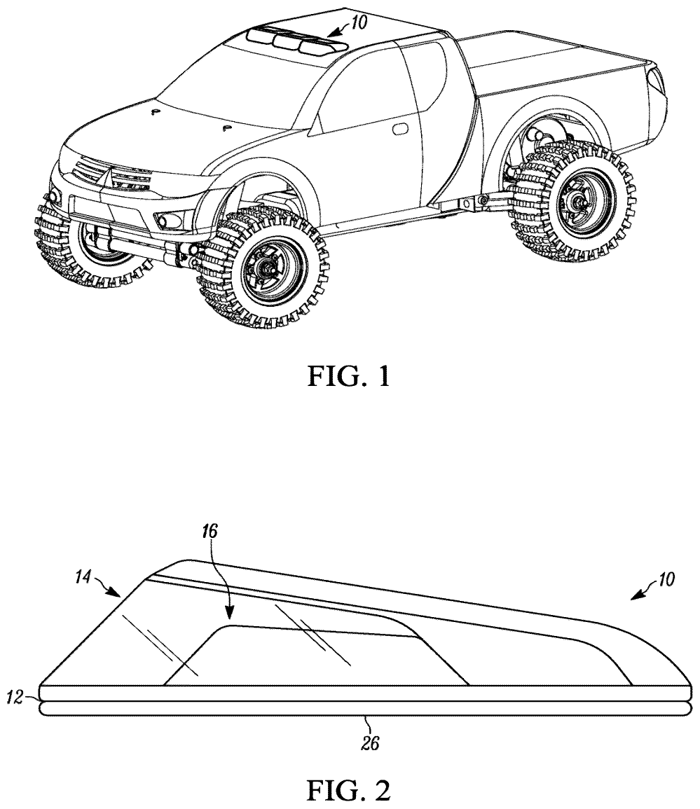

Referring now to the drawings and in particular to FIG. 1, the light assembly 10 is shown. The light assembly is configured for use in a number of different configurations, for example, the light assembly may be utilized, and the initial embodiment shown is directed to, a roof light that can be placed (i.e., removably coupled) on a vehicle 11, such as a truck. For example, and as shown in FIG. 1, the light assembly 10 may be coupled to or removably coupled to a roof 13 of a vehicle 11. The light assembly 10 may be positioned on the roof 13 above a windshield 15 of the vehicle 11, while avoiding other accessories or features of the roof (e.g., sunroof, moonroof, antenna, etc.). The light assembly 10 may be positioned within about 1 cm to about 10 cm; about 5 cm to about 50 cm; etc. of the windshield 15. In other configurations, the light assembly 10 may be a universal light which could be used in a number of different environments. For example, the light assembly 10 could be couplable to a personal watercraft, a kayak, a paddleboard, a trailer, and the like. In addition, other light assemblies are contemplated as well, such as automobile or other vehicle badges, marine navigation lights, side marker lights, center cab lights, and the like.

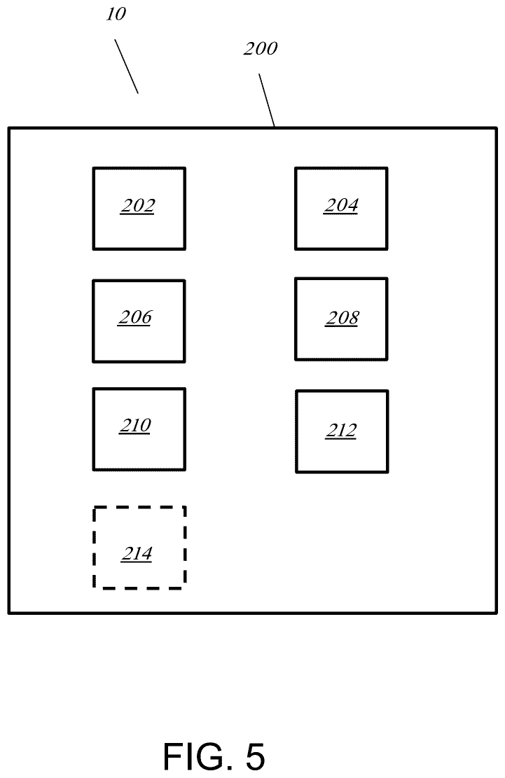

FIG. 5 illustrates an embodiment of light assembly 10 comprising a housing 200, one or more lights 202, control circuitry 204, one or more solar cells 206, one or more batteries 208, a light sensor 210, a movement sensor (e.g., an accelerometer) 212, and, optionally, one or more auxiliary sensors 214. The housing 200 may serve to mechanically protect and provide a water-tight seal enclosure for the one or more lights 202, control circuitry 204, one or more solar cells 206, one or more batteries 208, a light sensor 210, a movement sensor 212, and one or more auxiliary sensors 214. The housing 200 may be constructed of two or more materials. For example, the housing 200 may be constructed partially of a non-transparent plastic, forming a body, coupled to one or more transparent portions, forming a lens portion and/or a solar input portion. The one or more transparent portions may be formed of a material such as silicone, or the like. The one or more lights 202 may be oriented such that they project light, when in the “on” state, through a lens portion of the housing 200. The one or more batteries 208 may provide electrical power for the light assembly 10. The one or more solar cells 206 may be used to charge the one or more batteries 208. The light sensor 210 may be used to measure ambient light levels. The movement sensor 212 (e.g., an accelerometer) may be used to measure accelerations induced upon the light assembly 10 (e.g., from the vehicle it is coupled to). The control circuitry 204 includes integrated circuits and/or processors (e.g., a microprocessor) and may be interconnected with the one or more lights 210, the movement sensor 212, the light sensor 210, the one or more auxiliary sensors 214, the one or more batteries 208, and/or the one or more solar cells 206. The control circuitry 204 may control the activation/deactivation of the one or more lights 202 based on sensor measurements, the enabling/disabling of charging of the one or more batteries 208 (e.g., based on temperature readings from an auxiliary temperature sensor), and any other functionality.

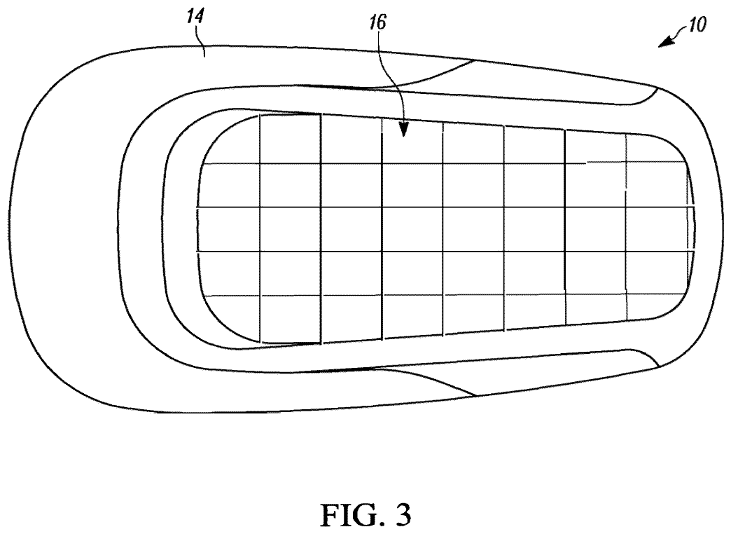

With reference to FIGS. 2-4, the light assembly 10 in the configurations shown, includes a base 12, housing 14, and electronic assembly 16. The base 12 includes lower surface 20 and upper surface 22 which define an outer perimeter 24. In the configuration shown, the base includes a raised portion 27 that is inclined. The raised portion 27 is surrounded by a substantially planar portion 28. In the configuration shown, and as will be explained, the electronic assembly is mounted to the raised portion, which places the lights 40 and one or more solar cells 44 in the proper orientation when in the operable position. In other configurations, the base 12 may have different characteristics or different features to position the electronic assembly 16 in a different configuration. Some of the base configurations may be substantially planar or may include various topographies. In the configuration shown, the base includes a molded polymer-based material, although other materials, such as metals and composites are likewise contemplated.

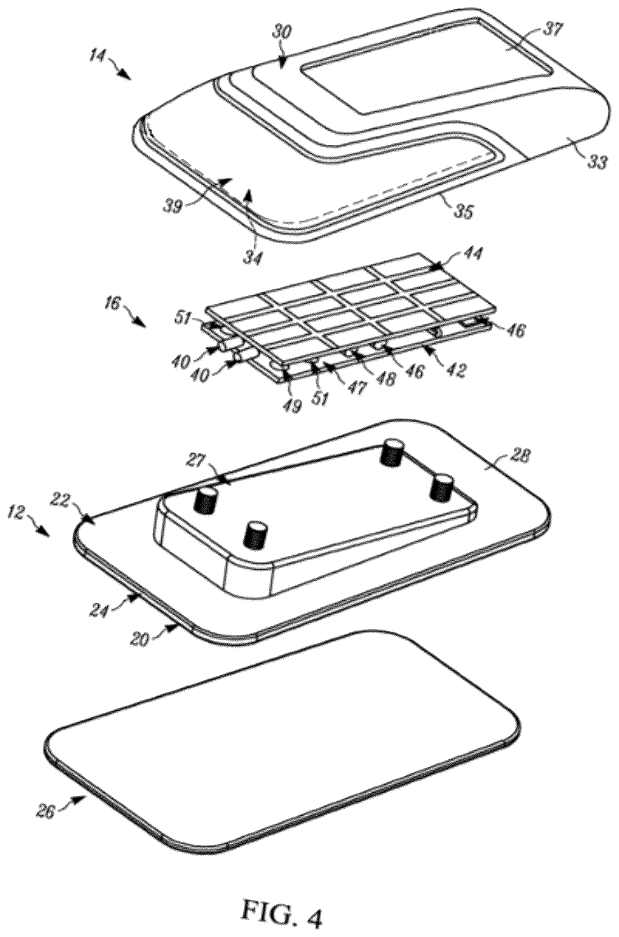

The outer perimeter 24, in the embodiment shown in FIG. 4, includes a substantially uniform outer edge that is generally along a single plane. The shape of the outer perimeter 24 is somewhat teardrop-like and rounded. Of course, other configurations are contemplated. The lower surface 20 generally includes a portion which defines a plane. An adhesive pad, such as adhesive pad 26 may be attached to the bottom surface and to an outside surface (such as the roof of a truck or the like). The adhesive pad may include a flexible member which is configured to follow the contours of the outside surface and the bottom surface and is capable of filling gaps therebetween. In other configurations, a liquid adhesive or other type of adhesive may be utilized. In still other embodiments, magnets or the like may be utilized.

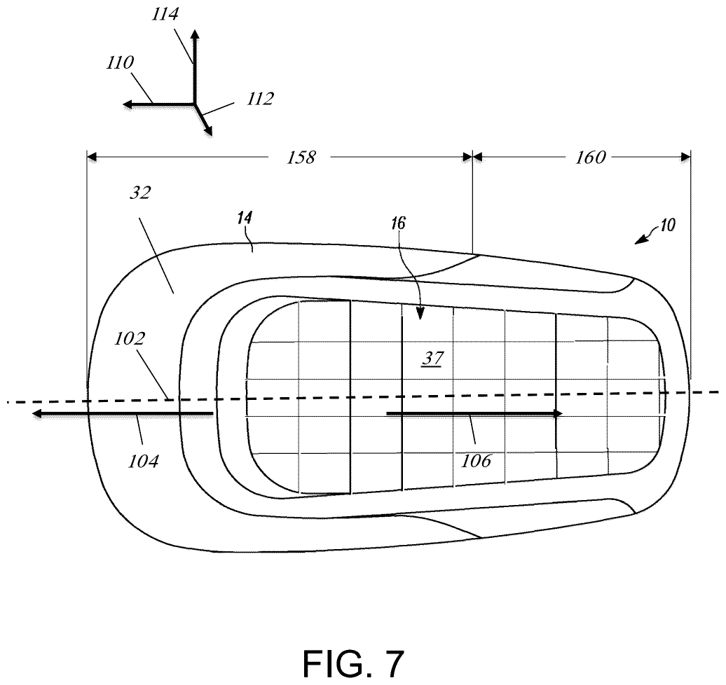

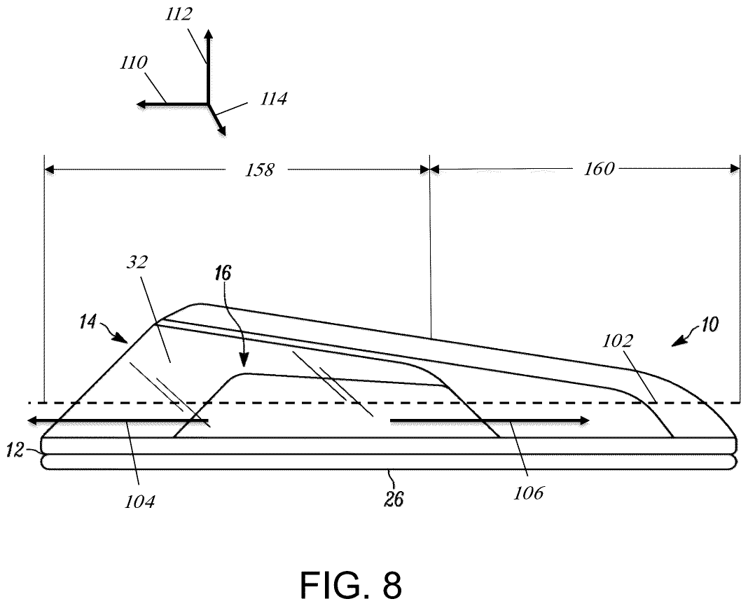

The housing 14, as shown in FIGS. 2-4, includes a cover portion 30, lens portion 32, outer surface 33, inner surface (opposite the outer surface 33), and mating surface 35. In the configuration shown, the cover portion 30 include a single material; whereas in other configurations, the cover portion 30 may include multiple different members or materials that are adhered, coupled, affixed, or otherwise joined together. The lens portion 32 corresponds to the portion through which it is desirable for light to project through. Further, light projection direction as used herein is defined by the point at which the light is generated (i.e., the light 40) and a portion of the lens 32 that the light projects through. An example light projection direction 104 is illustrated in FIGS. 7 and 8 with a three-dimensional axis for reference, including a y-axis 112, an x-axis 110, and a z-axis 114. FIG. 7 illustrate a top plan view of a light assembly 10 with a longitudinal axis 102 passing through a first portion 158 of the light assembly 10 and a second portion 160 of the light assembly 10. The first portion 158 may include at least a portion of the lens portion 32 and the second portion 160 may include at least a portion of the charging portion 37. The light projection direction 104 is approximately parallel to the longitudinal axis 102 of the light assembly 10. FIG. 7 shows the approximately parallel relationship of the light projection direction 104 and the longitudinal axis 102 from a top plan view of the light assembly 10. FIG. 8 shows the approximately parallel relationship of the light projection direction 104 and the longitudinal axis 102 from a side elevational view of the light assembly 10. In some embodiments, the lens portion 32 may include a transparent or translucent portion. A reflective portion may be formed to extend behind the lights 40, or, a reflective portion may be formed in the base, or may include a component separate to each of the base and the housing. In the embodiments shown in FIGS. 2-4, 7 and 8, the lens portion 32 wraps around the front and a portion of the sides of the housing. The lens portion faces at least partially horizontally, although variations are contemplated. Lights described herein may include one or more light emitting diodes (LED), or any other light variety known in the art. LED lights may be advantageous due to the low amount of energy they draw compared to other light varieties known in the art. Further, it has been contemplated that RGB/RGBY LED lights (and corresponding hardware) may be used as lights described herein. RGB/RGBY LEDs can produce a large array of light hues that may be selected by a user.

Additionally shown in FIGS. 2-4 and 7, the cover portion extends about the remainder of the housing 14 and includes a transparent or translucent charging portion 37. The charging portion 37 generally faces in a direction which can be optimized for direct view of the sun or other lights from which the solar cells may generate electrical energy. In the configuration shown, the remainder of the cover portion is substantially opaque. Of course, a number of different configurations are contemplated, and as will be understood the shape, color, and/or transparent/translucent/opaque configurations can be altered depending on the particular use and application. Preferably, the charging portion 37 is generally directed in an upward direction to generally maximize the exposure of the solar cells to ambient light from the sun or lights that are positioned above.

Illustrated in FIG. 4, the inner surface (opposite the outer surface 32) includes a generally concave surface, with the outer surface 33 being substantially convex. The inner surface (opposite the outer surface 32) defines a cavity 39 with an outer mating surface 35 which generally matches or corresponds to the outer perimeter 24 of the base 12 (shown in FIG. 2). In some embodiments, the two components can be joined there around in a generally sealed (and preferably waterproof) configuration, creating a sealed cavity 39. In the configuration shown, as the outer planar portion 28 of the base is substantially planar, the mating surface 35 is likewise substantially planar. In other configurations, the two may have various surface configurations. In addition, a third spacer member or the like may be incorporated, if desired.

It will be understood that in other configurations, the outer surface may have a configuration that mimics a logo or badge from a vehicle, with a lens portion that may extend outwardly, or which may extend entirely around the perimeter of the light. In other configurations, multiple lenses or multiple transparent/translucent portions separated by opaque portions are contemplated.

As illustrated in FIG. 4, the electronic assembly 16 is shown as comprising lights 40, control circuitry 42, one or more solar cells 44, one or more batteries 46, and one or more sensors 47. The one or more sensors may include a movement sensor 48 (e.g., an accelerometer), a light sensor 49, and one or more auxiliary sensors 51 (e.g., a magnetometer, a gyroscope, etc.). In the configuration shown, the electronic assembly 16 may include the control circuitry and a solar cell spaced apart from each other and substantially parallel to each other, with the lights 40 extending outwardly therefrom between the control circuitry and the solar cell. While a plurality of lights is shown, it will be understood that a single light may be provided.

Shown in FIG. 4, the one or more solar cells 44 are configured to charge the one or more batteries 46, so that power to the lights 40 can be maintained whether or not the solar cells are generating power (or generating sufficient power). Some embodiments utilize a collection of solar cells 44, forming one or more solar panels. As such, solar panels may be used to generate larger amounts of electrical energy to be stored in one or more batteries 46. For example, large embodiments with a large number of lights 40 may draw an increased amount of electrical energy and may benefit from utilizing higher capacity batteries, batteries with higher storage capacities, or multiple batteries. Large embodiments with increased electrical energy usage may benefit by utilizing solar panels for recharging of batteries. The control circuitry includes integrated circuits and/or processors (e.g., a microprocessor). Control circuitry may control the timing (i.e., on-off) of the lights. In addition, the control circuitry may be used to control the charging of the one or more batteries 46 by the one or more solar cells 44. Processors, including microprocessors, used within the control circuitry may include memory for the storage of operational instructions.

An auxiliary sensor 51 may be a temperature sensor. As such, the control circuitry may enable charging of the one or more batteries 46 when the temperature (e.g., a temperature measured on the battery) measured by the temperature sensor is within a predefined range, above a predefined threshold (e.g., not too cold), or below a predefined threshold (e.g., not too hot). The temperature may be measured within the light assembly or may measure the ambient temperature surrounding the light assembly. Enabling the charging of batteries within a predefined temperature range may reduce damage that may be caused by charging a battery that is too hot (e.g., above about 50° C. for many battery varieties) or too cold (e.g., below about 0° C. for Lithium-ion batteries), thus extending the life of the batteries. If the temperature is not within a predefined temperature range, the control circuitry may disable charging of the one or more batteries. Disabling the charging of batteries when the batteries are too hot or too cold may limit damage to the batteries, and thus, may extend the life of the batteries. Light assembly may include control elements for the enablement and disablement of charging. For example, the control circuitry may include one or more relays (e.g., electromechanical or solid state) that may open the charging circuit of the battery to disable charging or may close the charging circuit to enable charging. One of skill in the art of circuit design having the disclosure before them would be able to configure such a control circuitry interconnected with the microprocessor.

Further shown in FIG. 4, the one or more sensors 47 include sensors that may measure a number of different conditions. Based on these conditions, the control circuitry can either deactivate or activate the lights 40. For example, the one or more sensors 47 may include a movement sensor 48, such as an accelerometer. The accelerometer may be used to measure accelerations (i.e., output a signal indicative of an acceleration of an object, e.g., vehicle) induced upon the light assembly 10. Accelerations that may be experienced by the light assembly 10 may be induced by vibrations from the engine of a vehicle or a traveling vehicle (e.g., a car, a truck, a watercraft, a piece of equipment, a trailer, etc.) upon which the light assembly 10 is mounted. The accelerometer may measure accelerations induced upon the light assembly 10 from vibrations from a running or idling engine in a vehicle, a watercraft, a piece of equipment, etc. that the light assembly 10 is mounted to. Additionally, the accelerometer may measure the vibrational accelerations induced by the opening and shutting of a door on the vehicle. Further, the accelerometer may be used to measure the acceleration or deceleration of a vehicle to indicate if the vehicle is moving. The accelerometer measurements may be used as an indicator by the control circuitry as to direct the one or more lights 40 to an activated or deactivated state. In the same manner, the one or more sensors 47 may further include a light sensor 49 that can measure ambient light conditions. Light sensors used in embodiments described herein may include photoresistors (i.e., light dependent resistors), photodiodes, photovoltaic lights sensors, or any other light sensors known in the art. In some embodiments, the light sensor 49 may be positioned on the one or more solar cells 44, such that the light sensor 49 is in a suitable position for exposure to direct/indirect sunlight. In that manner, the light sensor can facilitate providing condition information to guide the control system to activate or deactivate the light. In one example, the control system can be configured to activate the one or more lights 40 in the event that the accelerometer measures accelerations greater than a predefined level and the light sensor measures a light level less than a predefined level (i.e., indicating that it is dark or that the ambient light is sufficiently low). Predefined levels may be acceleration minimum thresholds and/or are accelerations measured in a predefined orientation (e.g., vibrational accelerations from a moving vehicle may be approximately parallel to the gravitational accelerations) as to avoid erroneous activation of the one or more lights 40. For example, it would be advantageous to avoid directing the one or more lights 40 to an activated state when accelerations are induced by wind, rain, etc. Additionally, it may be advantageous for the predefined acceleration level to be greater than vibrational accelerations produced by a vehicle that is idling, for example to avoid illuminating the one or more lights while the vehicle is stationary, at least in some embodiments. The one or more lights 40 can be deactivated when either one of the conditions are not met. For example, the one or more lights 40 may be deactivated when the accelerometer does not measure accelerations greater than a predefined level for a predefined amount of time. The predefined amount of time may be within the range of about 10 second to about 120 seconds; about 15 seconds to about 60 seconds; about 20 seconds to about 45 seconds; etc. In other configurations, an additional manually operated on/off switch may be provided as the auxiliary sensor 51. An on/off switch may be advantageous, for example, during shipping and handling of light assemblies to avoid erroneous activation and, thus, avoiding the waste of battery power. It is further contemplated that an activation sensor may be provided as the auxiliary sensor 51. For example, the activation sensor may be a single use activation sensor (e.g., a touch sensor). The activation sensor may be activated once the light assembly is installed and ready to enter a use mode as described herein. In further configurations, a Bluetooth or other one-or two-way communication system may be utilized. In such a configuration, a smartphone or the like may include an application that can communicate with the control circuitry. The application can be used to set different parameters for the operation of the control circuitry and different operation for the one or more lights 40. The one or more lights can be programmed to operate in particular cycles. As such, the one or more lights may be deactivated or activated based on the accelerometer data coupled with the location data from the smartphone, and/or the time data from the smartphone, such that sunrise/sunset can be determined (even when the data is not directly available). It is also contemplated that the one or more sensors 47 may include GPS sensors which may cooperate with the other sensors to determine as to whether to deactivate or activate the system. The GPS sensors may also interface with the smartphone described herein. It is further contemplated that an embodiment may use an accelerometer to measure and indicate the direction of acceleration with respect to the orientation of the light assembly 10. Such an embodiment may use an accelerometer to indicate a direction of travel (e.g., opposite particular acceleration vectors) for the light assembly 10 with respect to the light projection direction of the light assembly 10. For example, if a light assembly 10 were mounted to a vehicle such that the light projection direction 104 (shown in FIGS. 7 and 8) of the light assembly 10 is substantially aligned with the forward direction of the vehicle or the reverse direction of the vehicle, the measurements from the accelerometer received by the control circuitry may indicate the direction of travel of the vehicle and whether the direction of travel is substantially aligned with the light projection direction 104 of the light assembly 10. The direction of travel may be determined based on the measured orientation by the accelerometer with respect to the orientation of the longitudinal axis 102 of the light assembly 10 and the orientation of a particular acceleration vector direction 106 measured by the accelerometer. For example, a particular acceleration vector direction 106 (shown in FIGS. 7 and 8) may be determined by being measured substantially perpendicular to gravitational acceleration that is approximately parallel to the y axis 112. An acceleration vector that is substantially perpendicular to gravitational acceleration is approximately parallel to the x axis 110 and the longitudinal axis 102 of the light assembly 10. Indication of the direction of travel being substantially aligned with the light projection direction 104 may be based on the measured acceleration vector 106 being substantially parallel to the longitudinal axis 102 of the light assembly 10 and oriented substantially opposite of the light projection direction 104. Direction of travel of the vehicle combined with other acceleration measurements measured by the accelerometer (e.g., vibrations of a moving vehicle), and/or ambient light levels measured by the light sensor 49, may be used to indicate when the control circuitry should activate the one or more lights 40. A use case may be a lighting assembly 10 installed (e.g., removably coupled) on a vehicle with the light projection direction 104 aligned with the front of a vehicle. When one or more aforementioned conditions (e.g., low ambient light levels, vibrations from a running vehicle) exist and the direction of travel is deemed to be substantially aligned with the light projection direction 104, the control circuitry may direct the one or more lights 40 to an “on” or activated condition. A further use case may be a light assembly 10 installed on the rear-end of a trailer with the light projection direction 104 aligned with the reverse direction of the trailer. When one or more aforementioned conditions (e.g., low ambient light levels, vibrations from a running vehicle) exist and the direction of travel is deemed to be substantially aligned with the light projection direction 104 (e.g., the trailer is being pushed by a vehicle in reverse), the control circuitry may activate the one or more lights 40. Additionally, a light assembly may include at least two light projection directions. For example, a bi-directional light assembly may include a first light with a first light projection direction through a first side of the light assembly and a second light with a second light projection direction substantially opposite the first light projection direction and through a second side of the light assembly. As such, a bi-directional light assembly may be installed on a vehicle with the first light projection direction substantially aligned with the path of the vehicle moving forward and with the second light projection direction substantially aligned with the path of the vehicle moving in reverse. Thus, the control circuitry may activate the first light when, among other possible conditions (e.g., ambient light level), the direction of travel is substantially aligned with the first light projection direction (i.e., the vehicle is moving forward). Conversely, the control circuitry may activate the second light when, among other possible conditions (e.g., ambient light level), the direction of travel is substantially aligned with the second light projection direction (i.e., the vehicle is moving in reverse). As such, the vehicle path, whether moving forward or in reverse, may be illuminated by the bi-directional light assembly. One of skill in the art will appreciate that a light assembly having first and second lights may further include first and second lens portions on opposite sides of the light assembly or a housing of the light assembly may substantially include a lens portion that encompasses first and second lights.

In operation, the user first receives the light assembly. The light assembly 10 may be provided in a pack of light assemblies. In the configuration wherein the light is couplable to a roof of a vehicle, a total of between about three lights and about seven lights may be provided in a pack. Once received, the user can determine where on the roof of the vehicle to position the lights. Once determined, the user can prepare the adhesive for attachment to the roof of the vehicle. In particular, generally, the adhesive may have a release sheet positioned thereover, which can be removed to expose the adhesive. The light assemblies described herein are advantageous for uniform performance. For example, it may be desired for a plurality of light assemblies to perform in unison (e.g., turning on or off at similar times). The described elements of the light assemblies herein provide the capability for uniform performance due to the light assemblies directing one or more lights to an “on” (or activated) or “off” (or deactivated) condition based on ambient light level measurements and at least one of: acceleration is greater than or less than a predefined level, or acceleration indicates the direction of travel of the vehicle is at least substantially aligned with a light projection direction of the light assembly.

With the adhesive exposed, the user can position the light assembly and adhere it to the vehicle. Once the one or more light assemblies are adhered to the vehicle, the user can either toggle the lights off and on with an auxiliary sensor 51 (e.g., a power switch). In some configurations, no such auxiliary sensor is provided, and instead, the lights are triggered to turn off and on with the cooperative predefined levels measured by the movement sensor (e.g., an accelerometer) and the light sensor. That is, when the movement sensor measures movement (which may be solely from the vehicle being on, or where it is actually moving in a direction), and the light sensor measures low or no light, the control circuitry can activate the one or more lights Conversely, when either condition is not met, then the one or more lights may be deactivated, or remain off. Additionally, it has been contemplated that the embodiments may accomplish ambient light level measurements without a light sensor, by instead measuring the level of electrical power (e.g., electrical current) produced by the solar cell. For example, if a current sensor were used to measure the electrical current passing from the solar cell to one or more batteries of a light assembly embodiment, and the electrical current were to be measured at a level less than a predefined amount, a condition for the control circuitry to activate the lights may be met.

Advantageously, the battery within the light is a secondary battery, in that it is rechargeable. The battery may comprise a NiCad, NIMH, Li-ion battery among other rechargeable battery solutions. The battery can be directly or indirectly recharged through the solar cells. That is, when the solar cells are exposed to sufficient light to generate electrical power, the electrical power is directed to the battery to recharge the same. Advantageously, the solar cell may be exposed substantially directly upwardly so as to maximize the amount of light to which the solar cells can be exposed. In other configurations, the solar cells may face in another direction (due to the surface upon which they are positioned, or the relative orientation thereof on an outside surface), and it may take more time for the battery to be charged by the solar cells. Preferably, the battery is configured to allow for extended (6-20 hour) powering of the one or more lights so that extended use is possible even if the solar cells have not been exposed to sufficient outside light to charge.

Advantageously, the battery within the light assembly is a secondary battery, in that it is rechargeable. The battery may comprise a NiCad, NIMH, Li-ion battery among other rechargeable battery solutions. The battery can be directly or indirectly recharged through the solar cells. That is, when the solar cells are exposed to sufficient light to generate electrical power, the electrical power is directed to the battery to recharge the same. Advantageously, the solar cell, in the embodiment shown is exposed almost directly upwardly to maximize the amount of light to which the solar cells can be exposed. In other configurations, the solar cells may face in another direction (due to the surface upon which they are positioned, or the relative orientation thereof on an outside surface), and it may take more time for the battery to be charged by the solar cells. Preferably, the battery is configured to allow for extended (6-20 hour) powering of the one or more lights so that extended use is possible even if the solar cells have not been exposed to sufficient outside light to charge.

It is further contemplated that the light assembly can be removably coupled to the roof of the vehicle (or to another outside surface to which it is attached). In such a configuration, the user can remove and replace the light as needed (i.e., move from vehicle to vehicle or from one outside surface to another).

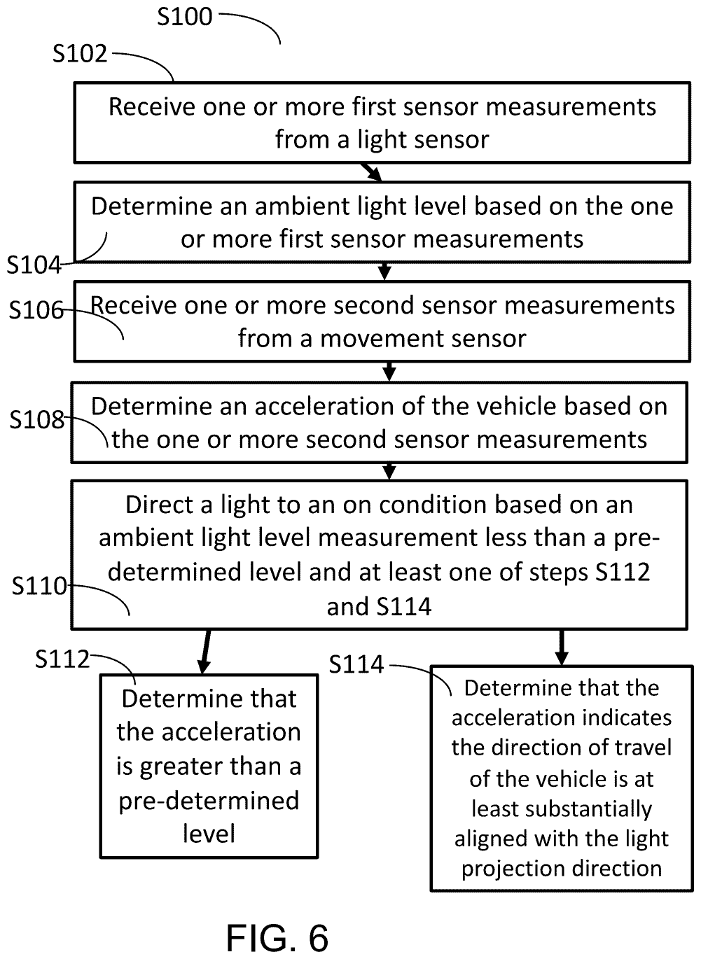

As shown in FIG. 6, a method S100 for using a light assembly includes receiving one or more first measurements from a light sensor at block S102; determining an ambient light level based on the one or more first sensor measurements at block S104; receiving one or more second measurements from a movement sensor at block S106; determining an acceleration of the vehicle based on the one or more second sensor measurements at block S108; and activating a light to an “on” condition based on an ambient light level measurement less than a predefined level and at least one of steps S112 and S114 at block S110. Block S110 includes determining that the acceleration is greater than a predefined level at block 112; or determining that the acceleration indicates the direction of travel of the vehicle is at least partially aligned with the light projection direction at block S114. The method S100 functions to illuminate the light assembly if certain conditions exist. The method S100 is used for vehicles but can additionally, or alternatively, be used for any suitable applications. The method S100 can be configured and/or adapted to function for any suitable operation.

As shown in FIG. 6, an embodiment of a method S100 for using a light assembly includes block S102, which recites receiving one or more first measurements from a light sensor. Block S102 functions to measure ambient light surrounding the light assembly.

As shown in FIG. 6, an embodiment of a method S100 for using a light assembly includes block S104, which recites determining an ambient light level based on the one or more first sensor measurements. Block S104 functions to determine the level of ambient light surrounding the light assembly.

As shown in FIG. 6, an embodiment of a method S100 for using a light assembly includes block S106, which recites receiving one or more second measurements from a movement sensor. Block S106 functions to measure accelerations produced by the vehicle, thus induced on the light assembly.

As shown in FIG. 6, an embodiment of a method S100 for using a light assembly includes block S108, which recites determining an acceleration of the vehicle based on the one or more second sensor measurements. Block S108 functions to determine the level and, possibly, orientation of the accelerations produced by the vehicle and induced onto the light assembly.

As shown in FIG. 6, an embodiment of a method S100 for using a solar powered light assembly includes block S110, which recites directing a light to an “on” condition based on an ambient light level measurement less than a predefined level and at least one of steps S112 and S114. Block S110 functions to illuminate the light of the light assembly if the environment surrounding the light assembly is sufficiently dark and if at least one or more additional conditions exist.

As shown in FIG. 6, an embodiment of a method S100 for using a light assembly includes block S112, which recites determining that the acceleration is greater than a predefined level. Block S112 functions as an optional additional condition for directing the light of the light assembly to an “on” condition. As described for FIG. 4, the movement sensor (e.g., an accelerometer) may measure accelerations greater than a predefined level, partially causing the control circuitry to direct one or more lights to an “on” condition. The predefined level of acceleration may be greater than vibrations or accelerations experienced by the light assembly due to environmental inputs (e.g., rain, wind, etc.) and/or vehicle idling. Accelerations greater than the predefined level may be generated from an engine running/idling or from a traveling vehicle.

As shown in FIG. 6, an embodiment of a method S100 for using a light assembly includes block S114, which recites determining that the acceleration indicates the direction of travel of the vehicle is at least partially aligned with the light projection direction. Block S114 functions as an optional additional condition for directing the light of the light assembly to an “on” condition. As described for FIG. 4, the measurements of the movement sensor (e.g., an accelerometer) received by the control circuitry may indicate the direction of travel of the vehicle and whether the direction of travel substantially aligns with the light projection direction, in part, causing the control circuitry to direct one or more lights to an “on” condition. For embodiments in which the light assembly illuminates the path of a vehicle (e.g., forward or reverse), it may be advantageous to only direct a light of the light assembly to the “on” condition if the vehicle is traveling in the direction that the light is illuminating (e.g., saving stored battery power).

Method S100 may be performed, at least in part, by a microprocessor electrically coupled to memory configured to store computer-readable instructions thereon. Steps and/or actions may be performed based predefined measurement levels and desired actions stored as instructions within the memory of the microprocessor.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor of the controller and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “light”may include, and is contemplated to include, a plurality of lights. At times, the claims and disclosure may include terms such as “a plurality,” “one or more,” or “at least one; ” however, the absence of such terms is not intended to mean, and should not be interpreted to mean, that a plurality is not conceived.

The term “about” or “approximately,” when used before a numerical designation or range (e.g., to define a length), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced.

Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLES

Example 1. A light assembly for removably coupling to a vehicle, the light assembly comprising: a housing defining a sealed cavity, the housing being at least partially transparent or translucent; at least one light configured to project light in a light projection direction through a lens portion of the housing; a solar cell configured to receive sunlight at least partially through the housing; a battery electrically coupled to the solar cell and the at least one light; two or more sensors, the two or more sensors including at least a movement sensor and a light sensor; and a microprocessor and memory configured to store computer-readable instructions thereon, wherein the at least one light, the battery, the solar cell, and the two or more sensors are electronically interconnected with the microprocessor and the memory, and wherein the microprocessor is configured to execute one or more operations based on the instructions stored in the memory, the operations comprising: receiving one or more first sensor measurements from the light sensor; determining an ambient light level based on the one or more first sensor measurements; receiving one or more second sensor measurements from the movement sensor; determining at least one of: an acceleration or a direction of travel of the vehicle from the one or more second sensor measurements; and activating the at least one light to an on condition when: the ambient light level is below a predefined light level, and at least one of: the acceleration of the vehicle is above a predefined acceleration level, or the acceleration of the vehicle indicates the direction of travel is at least substantially aligned with the light projection direction of the at least one light.

Example 2. The light assembly of any one of the preceding examples, but particularly example 1, wherein the movement sensor is an accelerometer. 3.

Example 3. The light assembly of any one of the preceding examples, but particularly example 1, wherein the two or more sensors further include a temperature sensor, wherein the operations further comprise: receiving one or more third sensor measurements from the temperature sensor; determining a temperature of the light assembly based on the one or more third sensor measurements; and when the temperature is within a predefined temperature range, enabling charging of the battery by the solar cell.

Example 4. The light assembly of any one of the preceding examples, but particularly example 1, wherein the two or more sensors further include a temperature sensor, wherein the operations further comprise: receiving one or more third sensor measurements from the temperature sensor; determining a temperature of the light assembly based on the one or more third sensor measurements; and when the temperature is outside a predefined temperature range, disabling charging of the battery by the solar cell.

Example 5. The light assembly of any one of the preceding examples, but particularly example 1, further comprising one or more auxiliary sensors comprising at least one of: a magnetometer, or a gyroscope.

Example 6. The light assembly of any one of the preceding examples, but particularly example 1, wherein the vehicle is a pickup truck or a semi-truck.

Example 7. A method of using a light assembly comprising a microprocessor and memory configured to store computer-readable instructions thereon, wherein the microprocessor is configured to execute one or more operations comprising: receiving one or more first sensor measurements from a light sensor; determining an ambient light level based on the one or more first sensor measurements; receiving one or more second sensor measurements from a movement sensor; determining at least one of: an acceleration of a vehicle or a direction of travel of the vehicle upon which the light assembly is mounted based on the one or more second sensor measurements; and directing a light to an on condition based on an ambient light level measurement less than a predefined level and at least one of: determining that the acceleration is greater than a predefined level, or determining that the acceleration indicates the direction of travel of the vehicle is at least substantially aligned with a light projection direction of the light assembly.

Example 8. The method of any one of the preceding examples, but particularly example 7, wherein the movement sensor is an accelerometer.

Example 9. The method of any one of the preceding examples, but particularly example 7, further comprising receiving one or more third sensor measurements from a temperature sensor.

Example 10. The method of any one of the preceding examples, but particularly example 9, further comprising: determining a temperature of the light assembly based on one or more third sensor measurements; and when the temperature is outside a predefined temperature range, disabling charging of a battery by a solar cell.

Example 11. The method of any one of the preceding examples, but particularly example 9, further comprising: determining a temperature of the light assembly based on one or more third sensor measurements; and when the temperature is within a predefined temperature range, enabling charging of a battery by a solar cell.

Example 12. A method of lighting a vehicle, comprising: adhering a light assembly on an outer surface of the vehicle, the light assembly comprising: a housing defining a sealed cavity, the housing having a lens portion and a charging portion, the lens portion and the charging portion each being at least one of transparent and translucent, at least one light, a solar cell, a battery, two or more sensors, the two or more sensors including at least an accelerometer and a light sensor, and a microprocessor; directing the at least one light to an on condition based on an ambient light level measurement from the light sensor less than a predefined level and at least one of: determining that an acceleration measured by the accelerometer is greater than a predefined level, or determining that the acceleration measured by the accelerometer indicates the direction of travel of the vehicle is at least substantially aligned with a light projection direction of the light assembly.

Example 13. The method of any one of the preceding examples, but particularly example 12, further comprising: receiving one or more temperature measurements from a temperature sensor of the one or more sensors; determining a temperature of the light assembly based on the one or more temperature measurements; and when the temperature is outside a predefined temperature range, disabling charging of the battery by the solar cell.

Example 14. The method of any one of the preceding examples, but particularly example 12, further comprising: receiving one or more temperature measurements from a temperature sensor of the one or more sensors; determining a temperature of the light assembly based on the one or more temperature measurements; and when the temperature is with a predefined temperature range, enabling charging of the battery by the solar cell.

Example 15. A light assembly for removably coupling to a vehicle, the light assembly comprising: a housing defining a sealed cavity, the housing being at least partially transparent or translucent; at least one light configured to project light through a lens portion of the housing defining a light projection direction; a battery electrically coupled to the at least one light; two or more sensors, the two or more sensors including at least a movement sensor and a light sensor; and a microprocessor and memory configured to store computer-readable instructions thereon, wherein the at least one light, the battery, and the two or more sensors are electronically interconnected with the microprocessor and the memory, wherein the light assembly is configured such that the light projection direction is substantially aligned with a direction of travel of the vehicle, and wherein the light assembly is configured to direct one or more lights to an on condition based on an ambient light level measurement from the light sensor less than a predefined level and at least one of: an acceleration measured by the movement sensor is greater than a predefined level, or an acceleration vector measured by the movement sensor is at least substantially parallel to a longitudinal axis of the light assembly and oriented substantially opposite of the light projection direction.

Example 16. The light assembly of any one of the preceding examples, but particularly example 15, further comprising a solar cell configured to receive sunlight at least partially through the housing.

Example 17. The light assembly of any one of the preceding examples, but particularly example 16, wherein the two or more sensors further include a temperature sensor, wherein the light assembly is configured to measure a temperature of the light assembly; and when the temperature is within a predefined temperature range, enable charging of the battery by the solar cell.

Example 18. The light assembly of any one of the preceding examples, but particularly example 15, wherein the movement sensor is an accelerometer.

Example 19. The light assembly of any one of the preceding examples, but particularly example 15, further comprising one or more auxiliary sensors comprising at least one of: a magnetometer, or a gyroscope.

Example 20. The light assembly of any one of the preceding examples, but particularly example 15, wherein the vehicle is a pickup truck or a semi-truck.

What is claimed is:

1. A light assembly for removably coupling to a vehicle, the light assembly comprising:
a housing defining a sealed cavity, the housing being at least partially transparent or translucent;
at least one light configured to project light in a light projection direction through a lens portion of the housing;
a solar cell configured to receive sunlight at least partially through the housing;
a battery electrically coupled to the solar cell and the at least one light;
two or more sensors comprising at least a movement sensor and a light sensor; and
a microprocessor and memory configured to store computer-readable instructions thereon, wherein the at least one light, the battery, the solar cell, and the two or more sensors are electronically interconnected with the microprocessor and the memory, and wherein the microprocessor is configured to execute one or more operations based on the instructions stored in the memory, the operations comprising:
receiving one or more first sensor measurements from the light sensor;
determining an ambient light level based on the one or more first sensor measurements;
receiving one or more second sensor measurements from the movement sensor;
determining at least one of: an acceleration or a direction of travel of the vehicle from the one or more second sensor measurements; and
activating the at least one light to an on condition when:
the ambient light level is below a predefined light level, and
at least one of: the acceleration of the vehicle is above a predefined acceleration level, or the acceleration of the vehicle indicates the direction of travel is at least substantially aligned with the light projection direction of the at least one light.

2. The light assembly of claim 1, wherein the movement sensor is an accelerometer.

3. The light assembly of claim 1, wherein the two or more sensors further comprise a temperature sensor, wherein the operations further comprise:
receiving one or more third sensor measurements from the temperature sensor;
determining a temperature of the light assembly or an ambient temperature surrounding the light assembly based on the one or more third sensor measurements; and
when the temperature is within a predefined temperature range, causing charging of the battery by the solar cell.

4. The light assembly of claim 1, wherein the two or more sensors further comprise a temperature sensor, wherein the operations further comprise:
receiving one or more third sensor measurements from the temperature sensor;
determining a temperature of the light assembly based on the one or more third sensor measurements; and w
when the temperature is outside a predefined temperature range, disabling charging of the battery by the solar cell.

5. The light assembly of claim 1, further comprising one or more auxiliary sensors comprising at least one of: a magnetometer, or a gyroscope.

6. The light assembly of claim 1, wherein the vehicle is a pickup truck or a semi-truck.

7. A method of using a light assembly comprising a microprocessor and memory configured to store computer-readable instructions thereon, wherein the microprocessor is configured to execute one or more operations comprising:
receiving one or more first sensor measurements from a light sensor;
determining an ambient light level based on the one or more first sensor measurements;
receiving one or more second sensor measurements from a movement sensor;
determining at least one of: an acceleration of a vehicle, or a direction of travel of the vehicle upon which the light assembly is mounted based on the one or more second sensor measurements; and
activating a light to an on condition based on an ambient light level measurement less than a predefined level and at least one of: determining that the acceleration is greater than a predefined level, or determining that the acceleration indicates the direction of travel of the vehicle is at least substantially aligned with a light projection direction of the light assembly.

8. The method of claim 7, wherein the movement sensor is an accelerometer.

9. The method of claim 7, further comprising receiving one or more third sensor measurements from a temperature sensor.

10. The method of claim 9, further comprising:
determining a temperature of the light assembly based on one or more third sensor measurements; and
when the temperature is outside a predefined temperature range, disabling charging of a battery by a solar cell electrically coupled to the battery.

11. The method of claim 9, further comprising:
determining a temperature of the light assembly based on one or more third sensor measurements; and
when the temperature is within a predefined temperature range, causing charging of a battery by a solar cell electrically coupled to the battery.

12. A light assembly for removably coupling to a vehicle, the light assembly comprising:
a housing defining a sealed cavity, the housing being at least partially transparent or translucent;
at least one light configured to project light through one or more lens portions of the housing and defining a light projection direction, wherein the at least one light is configured such that the light projection direction is substantially aligned with a direction of travel of the vehicle;
a battery electrically coupled to the at least one light;
two or more sensors comprising at least a movement sensor and a light sensor; and
a microprocessor and memory configured to store computer-readable instructions thereon, wherein the at least one light, the battery, and the two or more sensors are electronically interconnected with the microprocessor and the memory, wherein the microprocessor is configured to direct the at least one light to an on condition based on:
an ambient light level measurement from the light sensor less than a predefined level, and
at least one of: an acceleration measured by the movement sensor greater than a predefined level, or an acceleration vector measured by the movement sensor at least substantially parallel to a longitudinal axis of the light assembly and oriented substantially opposite of the light projection direction.

13. The light assembly of claim 12, further comprising a solar cell electrically coupled to the battery and the at least one light and configured to receive sunlight at least partially through the housing.

14. The light assembly of claim 13, wherein the two or more sensors further comprise a temperature sensor, wherein the microprocessor is configured to receive a measured temperature of the at least one light; and when the temperature is within a predefined temperature range, cause charging of the battery by the solar cell.

15. The light assembly of claim 12, wherein the movement sensor is an accelerometer.

16. The light assembly of claim 12, further comprising one or more auxiliary sensors comprising at least one of: a magnetometer, or a gyroscope.

17. The light assembly of claim 12, wherein the vehicle is a pickup truck or a semi-truck.
